(19) United States
(12) Patent Application Publication
(10) Pub. No.: US 2019/0384957 A1
(43) Pub. Date: Dec. 19, 2019

(54) Biometric Submission System

(71) Applicants: John Albert Guzzwell, St. John's (CA); Edythe Patricia LeFeuvre, St. John's (CA); Rodney David Hale, St. John's (CA); Ivi Hermanto, Mount Pearl (CA)

(72) Inventors: Edythe Patricia LeFeuvre, St. John's (CA); Rodney David Hale, St. John's (CA); Ivi Hermanto, Mount Pearl (CA)

(21) Appl. No.: 16/011,876

(22) Filed: Jun. 19, 2018

(51) Int. Cl. G06K 9/00; G06T 7/00

(52) U.S. Cl. CPC G06K 9/001; G06T 7/0002; G06K 9/00107

(57) ABSTRACT

A method for capturing digital images of friction ridge prints from the fingers/palms of a subject that have acceptable quality.

The method includes
a livescan device;
a means of obtaining digital images of inked prints; and
a software program that captures and stores print images and evaluates their quality.

Fingerprint/palmprint images to be submitted to databases must be of suitable quality for automated fingerprint/palmprint identification software. There are sometimes problems capturing prints of suitable quality when using livescan devices. If a livescan image quality is below a threshold, the program prompts the user to produce an inked version of the same finger/palm on a substrate and then scan or digitally photograph the inked print impression. The program evaluates the quality of the digital inked image. If the quality exceeds the threshold the image is selected for submission to the database.

### CROSS-REFERENCES TO RELATED APPLICATIONS

This application is related to Canadian patent application number 2,952,510 filed Dec. 23, 2016. No priority is claimed.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The invention pertains to the capture and quality assessment of friction ridge impressions i.e. prints from the fingers and palms of human hands.

### Description of Related Art

Friction ridge skin is most commonly known as the skin that is found on the palms of the hands and the bottoms of the feet of humans and other primates. This type of skin is corrugated, which means it features tiny furrows or valleys between ridges. These ridges provide friction that helps the hands and fingers grip objects. These ridges also provide the feet with a stable surface to walk without slipping and sliding on smooth surfaces. The ridge patterns have distinctive features such as ridge endings (the points at which friction ridges terminate) and bifurcations (the points at which one friction ridge divides into two friction ridges). Note that the terms fingerprint, palm print and footprint refer to an impression left by the friction skin or an image of the friction skin rather than the anatomical structure itself. For the remainder of this document the term “print” will mean fingerprint and/or palm print. The prints may be from any of the ten fingers of the left and right hands, and any components of the palms of the right and left hands.

A digital image record of a person's fingerprint or palm print is captured either directly using a livescan device (see FIG. 1 feature 10) or by scanning or digitally photographing an inked impression of a person's finger. A traditional method of capturing fingerprints is to apply a substance (such as ink) to the fingers and palms that will transfer friction ridge impressions when the fingers and/or palms are pressed against a substrate (e.g. fingerprint cards). A print captured in this manner is typically called an inked print.

Many organizations including but not limited to government agencies, law enforcement agencies, and commercial corporations at the international, national and local level compile databases that contain fingerprint and/or palm print records of individuals. These print databases are major components of automated fingerprint identification systems (AFIS) and automated fingerprint verification (AFV) systems.

Automated fingerprint (or palm print) identification is the process of automatically matching one or many unknown prints against a database of known prints. In some cases unknown prints are also included in the database. This is often the case for law enforcement applications where unknown prints from unsolved cases are included in a database of known criminal prints. An automated fingerprint identification system (AFIS) consists of a database of prints plus matcher software that is used to search a print against the database to try to find the closest match or matches. This is sometimes called a 1:N search where “N” represents the number of records in the database. AFIS is used by law enforcement agencies for criminal identification initiatives, namely identifying a person suspected of committing a crime or linking a suspect to other unsolved crimes.

Automated fingerprint verification (AFV) is a closely related technique used in applications such as attendance and access control systems. It also consists of a database of prints plus matcher software, however in this case the matcher is verifying that the prints submitted for an individual match the prints for that individual contained in the database. This verification search is sometimes called a 1:1 search. On a technical level, verification systems verify a claimed identity whereas identification systems determine identity based solely on prints.

Both AFIS and AFV have been implemented in large-scale civil identification projects. The chief purpose of a civil AFIS or AFV is to prevent multiple enrollments in an electoral, welfare, driver licensing, or similar system. Another benefit of a civil AFIS is its use in background checks for job applicants for highly sensitive posts and educational or volunteer personnel who have close contact with children. Background AFIS checks are typically conducted to determine if an individual has a criminal record.

Digital print images are typically submitted to AFIS and MV databases to i) add the images to the database to establish a baseline print record of an individual in the print database or ii) search the print database to determine if the submitted print record matches an existing entry in the print database.

An ideal digital print image of friction ridge skin has clear and distinct ridges and valleys. It is known that the matcher software algorithms of AFIS and AFV systems are sensitive to fingerprint image quality as indicated by features including but not limited to:
the clarity of ridges and valleys;
measures of the number and quality of minutiae (ridge endings and bifurcations); and
the size of the friction ridge area.

Print images to be submitted to databases for AFIS, AFV or other applications must be of suitable quality for comparison and searching with matcher software. The prints must be captured in digital format for submission to and storage in a database. As stated previously, a digital image of a person's fingerprint or palm print is captured either directly using a livescan device (see FIG. 1 feature 10) or by scanning or digitally photographing an inked impression of a person's finger on a substrate (e.g. a fingerprint card).

A card used to capture inked prints of all ten fingers is typically called a tenprint card. A tenprint card is illustrated in FIG. 1 feature 60. The process of scanning digital images of prints by placing a tenprint card (or other substrate) containing inked prints i) onto a flatbed scanner (see FIG. 1 feature 30) or ii) into an automated feed document/card scanner (see FIG. 1 feature 40) may be called cardscan. Digital images of inked prints may also be obtained by photographing the prints using a digital camera (see FIG. 1 feature 50) that is handheld, mounted on a frame or integrated into an image capture system.

A livescan is a device used for scanning live prints electronically for submission to a print database. The process of obtaining the prints by way of livescan typically employs rolling an individual's fingers onto a glass platen above a sensor unit that records the rolled prints or by placing fingers or palms flat onto the platen to obtain flat prints. There are also contactless systems that do not require fingers or palms to touch a platen. Livescan sensor technologies include but are not limited to:
Optical
   FTIR—Frustrated Total Internal Reflection
   Optical fibres
   Electro-optical
   Multispectral imaging
Solid State
   Capacitive
   Thermal
   Electric field
   Piezoelectric
Ultrasound
Contactless
   Digital camera images
   Composite digital camera images
   Multi-focus digital images combined into a 3D global finger shape
   Line scanning optical camera
   Moving structured light illumination
   Fixed structured light illumination on moving finger
   Composite digital camera images with structured light
   Stereoscopic digital images using multiple color illumination to capture 3D representation
   Digital camera image with multispectral imaging for liveness detection
   Polarized reflected light

### BRIEF SUMMARY OF THE INVENTION

The Biometric Submission System is a friction ridge image capture system consisting of a computer program, a livescan device (see FIG. 1 feature 10) and a means of capturing an image of one or more inked fingerprints (or palmprints). The fingerprint images are stored in a file for submission to a database. The livescan device is used to capture fingerprint images. The computer program calculates the quality rating of each fingerprint image. If the quality rating is above a threshold the print is added to the submission file. If the quality rating is below the threshold the user is prompted to try to capture the fingerprint with livescan again. If the quality threshold is not exceeded after a number of attempts, the user is prompted to produce an inked fingerprint of the corresponding finger and then to capture a digital image of the inked print. The quality rating of the digital inked image is calculated by the computer program and compared to the highest quality livescan image of the fingerprint. The program displays the quality rating of the highest quality image. If the quality rating is above the threshold the computer program prompts the user to store the image in the submission file. If the quality is below the threshold the computer program may also allow the user to override the quality threshold and store the image in the submission file. The process is repeated until the required print images are captured and stored in the submission file.

### BRIEF DESCRIPTION OF THE SEVERAL VIEWS OF THE DRAWING

FIG. 1 illustrates the components of Biometric Submission System. FIG. 1 feature 10 illustrates a finger that has been placed on a typical livescan device in order to capture a fingerprint. FIG. 1 feature 20 illustrates a desktop computer system consisting of a central processing unit, a monitor, a keyboard and a mouse. FIG. 1 feature 30 illustrates a typical flatbed scanner. FIG. 1 feature 40 illustrates a typical cardscan device. FIG. 1 feature 50 illustrates a typical digital camera. FIG. 1 feature 60 illustrates an inked tenprint card.

### DETAILED DESCRIPTION OF THE INVENTION

There are problems capturing fingerprints/palm prints with livescan devices. The Canadian Friction Ridge Working Group has published a position statement noting the detrimental impact on fingerprint quality due to anomalies (blurring and stitching) caused by some livescan devices (Canadian Friction Ridge Working Group, “Position statement—Impact of Livecan Anomalies on Friction Ridge Identification” Sep. 8, 2014). The Eurodac database of EU asylum seeker fingerprints has noted that up to 20% of fingerprint submissions are found to be unreadable (Eurodac Supervision Coordination Group, “Report on the coordinated inspection on unreadable fingerprints” May 2013). A number of studies have found that dermatologic diseases which affect 5% of the population render fingerprints to be unreadable by livescan devices (Drahansky, M., Brezinova, E., Hejtmankova, D., and F. Orsag, “Fingerprint Recognition Influenced by Skin Diseases” Intn'l J. of Bio-Science and Bio-Technology V.2 No. 4 Dec. 2010: 11-20; Lee, C. K., Chang, C. C., Johar, A., Puwira, O., and B. Roshidah, “Fingerprint Changes and Verification Failure Among Patients with Hand Dermatitus” JAMA Dermatol. 2013; 149(3):294-299). Inked prints are typically better quality in such instances.

In addition, sometimes it is not possible for an individual to travel to the location of a livescan station so the only option is for the individual to mail or courier a tenprint card to be scanned via cardscan or digitally photographed in order to submit their prints.

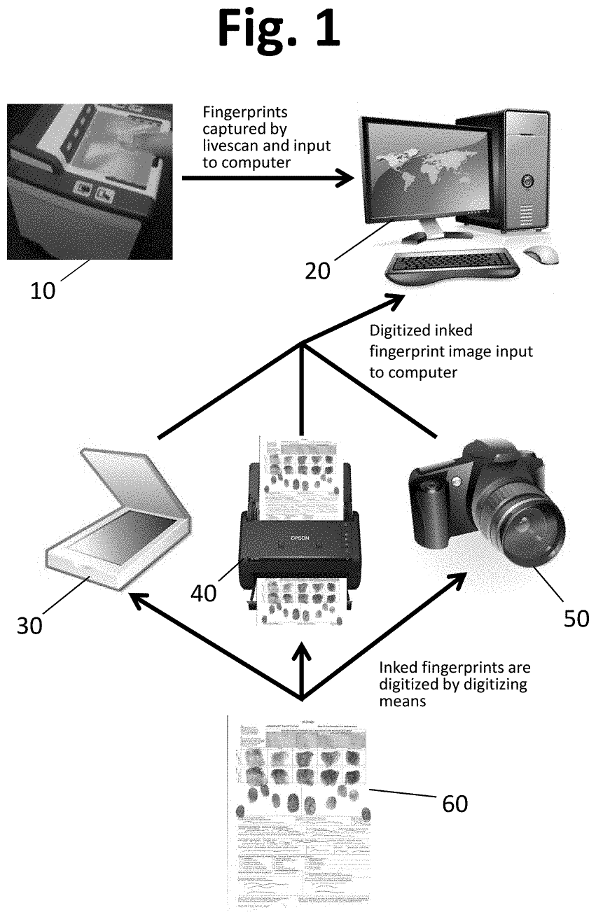

The preferred embodiment of the Biometric Submission System (BSS) includes a computer program implemented on a computer (see FIG. 1 feature 20), a livescan device (see FIG. 1 feature 10) plus a means of obtaining a digital image of inked prints. The means of obtaining a digital image of an inked print may include but is not limited to:
a flatbed scanner (see FIG. 1 feature 30)
an automated feed document/card scanner (see FIG. 1 feature 40)
a digital camera (see FIG. 1 feature 50)

In comparison to livescan alone, the BSS increases the probability of capturing prints of quality suitable for submission to a database by providing both livescan and a means of obtaining digital images of inked prints.

The BSS computer program includes a GUI (graphical user interface) and manages fingerprint image capture, entry of print donor data, storage of images and data, formatting of images and data into a submission file and transmission of the submission file to a database. The computer program also includes:
a quality evaluation algorithm that calculates the quality rating of a digital image of a print;
a quality comparison algorithm that calculates which of several digital images of a print from a unique source has the highest quality rating; and
a thresholding algorithm that determines if the quality rating of a print image exceeds the threshold or not.

The BSS computer program integrates the process of capturing prints via livescan and digitization of inked prints into one workflow to increase the probability of capturing higher quality print images in comparison to livescan alone.

The typical print capture workflow with preferred embodiment of the BSS is as follows:
1. The BSS GUI prompts the user to sequentially capture a set of an individual's prints (ten individual fingers, rolled and/or tapped, and if required, palms and writer's palms) using the livescan (see FIG. 1 feature 10).
2. The computer program implemented on a computer system (see FIG. 1 feature 20) calculates the quality rating of each print image as it is captured.
3. If the livescan cannot capture a print with a quality rating above a threshold after a set number of attempts, the user is prompted by the computer program to skip to the next print.
4. After the user has attempted to capture all required prints using the livescan, the BSS GUI prompts the user to capture any skipped prints by inking the skipped prints onto a tenprint card (see FIG. 1 feature 60) or other substrate and capturing a digital image of the prints on the card.
5. The digital image of the print(s) on the card may be obtained by scanning the card using a flatbed scanner (see FIG. 1 feature 30), by scanning with an automated feed document/card scanner (see FIG. 1 feature 40), by taking a photo image with a digital camera (see FIG. 1 feature 50) or by other means.
6. For each skipped print, the BSS compares the quality ratings of the livescan image and the scanned inked Image and selects the image with the best (i.e. highest) quality rating.
7. If the quality rating of the best image is above a threshold quality rating value the print is added to the submission file.
8. If the quality rating is below the threshold, the user may implement a manual quality override to permit the print to be added to the submission file.
9. After all the required prints are captured, the user inputs the individual's information as prompted by the BSS.
10. The BSS formats the individual's fingerprint images and information into a submission file for submission to the database.
11. User submits the file to the database.

1. The invention claimed is a method for capturing digital images of friction ridge prints from the fingers (fingerprints) or palms (palm prints) of an individual that have acceptable quality, such method comprising:
a computer-implemented user interface for prompting a user through the process of capturing friction ridge prints from an individual;
a livescan means of capturing a livescan image of a print;
a means of capturing a digital image of one or more inked prints (i.e. prints that were produced by applying a substance (such as ink) to the fingers and/or palms that transferred friction ridge impressions when one or more fingers and/or palms were pressed against a card or other substrate);
a computer-implemented quality evaluation means for evaluating the quality of a digital image of a print;
a computer-implemented quality comparison means for determining which of several digital images of a print from a unique friction ridge source has the highest quality; and
a computer-implemented thresholding means for determining if the quality of the print exceeds a threshold or not.

2. The invention claimed is the invention of claim 1 wherein the fingerprints of all ten fingers are attempted to be captured using the livescan means.

3. The invention claimed is the invention of claim 2 wherein for each unique finger, a livescan fingerprint image is captured and the quality evaluation means is used to determine the quality of the print image.

4. The invention claimed is the invention of claim 3 wherein the computer-implemented thresholding means is used to determine if the quality of the print exceeds the threshold or not.

5. The invention claimed is the invention of claim 4 wherein if the quality of a fingerprint captured by livescan is determined to be below a set threshold after a specified number of capture attempts, the user is prompted by the computer-implemented user interface to produce an inked fingerprint of the corresponding finger and capture a digital image of the inked print i.e. a digital inked image.

6. The invention claimed is the invention of claim 5 wherein the computer-implemented comparison means compares the digital inked image to the livescan image, determines which has the highest quality, and then the computer-implemented user interface indicates this to the user.

7. The invention claimed is the invention of claim 6 wherein the computer-implemented thresholding means is used to determine if the quality of the print image with the highest quality exceeds a set threshold or not and then the computer-implemented user interface indicates the result to the user.

8. The invention claimed is the invention of claim 7 wherein if the threshold is exceeded, the computer-implemented user interface prompts the user to save the print image for submission to a database.

9. The invention claimed is the invention of claim 7 wherein if the threshold is not exceeded, the computer-implemented user interface prompts the user to omit the print image for that finger from the submission file.

10. The invention claimed is the invention of claim 7 wherein if the threshold is not exceeded, the computer-implemented user interface prompts the user to override the threshold and save the print image for submission to a database.

11. The invention claimed is the invention of claim 1 where the livescan sensor is based on one of the following technologies:
Optical:
FTIR—Frustrated Total Internal Reflection;
Optical fibres;
Electro-optical;
Multispectral imaging; or
Solid State:
Capacitive;
Thermal;
Electric field;
Piezoelectric; or
Ultrasound; or
Contactless:
Digital camera images;
Composite digital camera images;
Multi-focus digital images combined into a 3D global finger shape;
Line scanning optical camera;
Moving structured light illumination;
Fixed structured light illumination on moving finger;
Composite digital camera images with structured light;
Stereoscopic digital images using multiple color illumination to capture 3D representation;
Digital camera image with multispectral imaging for liveness detection; or
Polarized reflected light.

12. The invention claimed is the invention of claim 1 where the means of capturing a digital image of one or more prints that were produced by applying a substance (such as ink) to the fingers and/or palms that transferred friction ridge impressions when one or more fingers and/or palms were pressed against a card or other substrate is one of the following:
a flatbed scanner;
an automated feed document/card scanner; or
a digital camera.

13. The invention claimed is the invention of claim 1 where the quality is calculated based on the NFIQ (NIST Fingerprint Image Quality) or NFIQ 2.0 open source algorithms published by NIST (National Institute of Standards and Technology).
